(19) United States
(12) Patent Application Publication
(10) Pub. No.: US 2025/0193889 A1
(43) Pub. Date: Jun. 12, 2025

(54) METHOD FOR IMPLICIT ASSOCIATION BETWEEN MULTI-TRP PUSCH TRANSMISSION AND UNIFIED TCI STATES

(71) Applicant: Telefonaktiebolaget LM Ericsson (publ), Stockholm (SE)

(72) Inventors: Siva Muruganathan, Stittsville (CA); Shiwei Gao, Nepean (CA); Andreas Nilsson, Göteborg (SE)

(21) Appl. No.: 18/842,190

(22) PCT Filed: Mar. 6, 2023
(86) PCT No.: PCT/IB2023/052094

§ 371 Date: Aug. 28, 2024

Related U.S. Application Data
(60) Provisional application No. 63/316,774, filed on Mar. 4, 2022.

(51) Int. Cl. H04W 72/21; H04W 72/232

(52) U.S. Cl. CPC H04W 72/21; H04W 72/232

(57) ABSTRACT

Systems and methods for implicit associate between multiple TRP PUSCH transmission and unified TCI states are provided. In some embodiments, a method performed by a UE for transmission using two activated/indicated unified TCI states includes: receiving a configuration comprising: unified TCI states; and/or two SRS resource sets to be used for an uplink transmission; receiving a first DCI that activates/indicates a pair of unified TCI states; and associating a first unified TCI state to the first of the two SRS resource sets, and associating a second unified TCI state to the second of the two SRS resource sets. In this way, an implicit association is provided between each SRS resource set with an activated/indicated unified TCI state. This extends unified TCI state framework to PUSCH transmission towards multiple TRPs without the need to explicitly configure association parameters. Introducing such explicit configuration parameter for association would increase control signaling overhead.

### RELATED APPLICATIONS

This application claims the benefit of provisional patent application Ser. No. 63/316,774, filed Mar. 4, 2022, the disclosure of which is hereby incorporated herein by reference in its entirety.

### TECHNICAL FIELD

The present disclosure relates generally to transmission using activated/indicated unified Transmission Configuration Indication (TCI) states.

### BACKGROUND

### NR Frame Structure and Resource Grid

NR uses CP-OFDM (Cyclic Prefix Orthogonal Frequency Division Multiplexing) in both downlink (i.e., from a network node, gNB, or base station, to a user equipment or UE) and uplink (i.e., from UE to gNB). DFT spread OFDM is also supported in the uplink. In the time domain, NR downlink and uplink are organized into equally-sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel (PDCH), either physical downlink shared channel (PDSCH) or physical uplink shared channel (PUSCH).

Different subcarrier spacing values are supported in NR. The supported subcarrier spacing values (also referred to as different numerologies) are given by Δf=(15×2^{μ})kHz where μ∈0,1,2,3,4. Δf=15 kHz is the basic subcarrier spacing. The slot durations at different subcarrier spacings is given by 1/2^{μ} ms.

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink and uplink transmissions can be either dynamically scheduled in which the gNB transmits a DL assignment or an uplink grant via downlink control information (DCI) over PDCCH (Physical Downlink Control Channel) to a UE for each PDSCH or PUSCH transmission, or semi-persistent scheduled (SPS) in which one or more DL SPS or UL configured grants (CGs) are semi-statically configured and each can be activated or deactivated by a DCI.

### QCL and TCI States

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the PDSCH DMRS. When UE receives the PDSCH DMRS, it can use the measurements already made on the TRS to assist the DMRS reception.

Information about what assumptions can be made regarding QCL is signaled to the UE from the network. In NR, four types of QCL relations between a transmitted source RS and transmitted target reference signal (RS) were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a CSI-RS for tracking (TRS) for time/frequency offset estimation. To be able to use any QCL reference, the UE would have to receive it with a sufficiently good SINR. In many cases, this means that the TRS must be transmitted in a suitable beam to a certain UE.

To introduce dynamics in beam and Transmission Reception Point (TRP) selection, the UE can be configured through RRC signaling with up to 128 Transmission Configuration Indicator (TCI) states. The TCI state information element is shown below (TCI State information element (Extracted from 3GPP TS 38.331)):

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI state contains QCL information related to one or two RSs. For example, a TCI state may contain CSI-RS1 associated with QCL Type A and CSI-RS2 associated with QCL TypeD. If a third RS, e.g., the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates via MAC CE one TCI state for PDCCH (i.e., provides a TCI state for PDCCH) and up to eight TCI states for PDSCH. The number of active TCI states the UE support is a UE capability, but the maximum is 8.

Assume a UE has 4 activated TCI states (from a list of totally 64 configured TCI states). Hence, 60 TCI states are inactive for this particular UE and the UE needs not be prepared to have large scale parameters estimated for those inactive TCI states. But the UE continuously tracks and updates the large-scale parameters for the RSs in the 4 active TCI states. When scheduling a PDSCH to a UE, the DCI contains a pointer to one activated TCI state. The UE then knows which large scale parameter estimate to use when performing PDSCH DMRS channel estimation and thus PDSCH demodulation.

As long as the UE can use any of the currently activated TCI states, it is sufficient to use DCI signaling. However, at some point in time, none of the source RSs in the currently activated TCI states can be received by the UE, i.e., when the UE moves out of the beams in which the source RSs in the activated TCI states are transmitted. When this happens (or actually before this happens), the gNB would have to activate new TCI states. Typically, since the number of activated TCI states is fixed, the gNB would also have to deactivate one or more of the currently activated TCI states.

The two-step procedure related to TCI state update is depicted in FIG. 3. Two-stage TCI state update. The selected TCI state is selected from the activated set of TCI states using DCI, and the set of activated TCI states is updated using MAC CE

### TCI States Activation/Deactivation for UE-Specific PDSCH Via MAC CE

The details of the MAC CE signaling that is used to activate/deactivate TCI states for UE specific PDSCH are provided. The structure of the MAC CE for activating/deactivating TCI states for UE specific PDSCH is given in FIG. 4. TCI States Activation/Deactivation for UE-specific PDSCH MAC CE (Extracted from FIG. 6.1.3.14-1 of 3GPP TS 38.321).

As shown in FIG. 4, the MAC CE contains the following fields:
Serving Cell ID: This field indicates the identity of the Serving Cell for which the MAC CE applies. The length of the field is 5 bits;
BWP ID: This field contains the ID corresponding to a downlink bandwidth part for which the MAC CE applies. The BWP ID is given by the higher layer parameter BWP-Id as specified in 3GPP TS 38.331. The length of the BWP ID field is 2 bits since a UE can be configured with up to 4 BWPs for DL;
A variable number of fields Tᵢ: If the UE is configured with a TCI state with TCI State ID i, then the field Tᵢ indicates the activation/deactivation status of the TCI state with TCI State ID i. If the UE is not configured with a TCI state with TCI State ID i, the MAC entity shall ignore the Tᵢ field. The Tᵢ field is set to “1” to indicate that the TCI state with TCI State ID i shall be activated and mapped to a codepoint of the DCI Transmission Configuration Indication field, as specified in 3GPP TS 38.214/38.321. The Tᵢ field is set to “0” to indicate that the TCI state with TCI State ID i shall be deactivated and is not mapped to any codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to “0” in NR Rel-15.

Note that the TCI States Activation/Deactivation for UE-specific PDSCH MAC CE is identified by a MAC PDU subheader with logical channel ID (LCID) as specified in Table 6.2.1-1 of 3GPP TS 38.321. The MAC CE for Activation/Deactivation of TCI States for UE-specific PDSCH has variable size.

### TCI State Indication for UE-Specific PDSCH Via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 5. Example of DCI indication of a TCI state. The DCI gives a pointer into the ordered list of activated TCI states.

DCI code point 0 indicates the first TCI state index in the list of TCI states, DCI code point 1 indicates the second TCI state index in the list, and so on.

### Multi-TRP TCI State Operation

In Release 16, a multi-TRP (multiple-transmission reception point) operation was specified and it has two modes of operation, single DCI based multi-TRP and multiple DCI based multi-TRP.

In NR Rel-16, multiple DCI scheduling is for multi-TRP in which a UE may receive two DCIs each scheduling a PDSCH/PUSCH. Each PDCCH and PDSCH are transmitted from the same TRP.

For multi-DCI multi-TRP operation, a UE needs to be configured with two CORESET pools, each associated with a TRP. Each CORESET pool is a collection of CORESETs that belongs to the same CORESET pool. A CORESET pool index can be configured in each CORESET with a value of 0 or 1. For the two DCIs in the above example, they are transmitted in two CORESETs belonging to different CORESET pools (i.e., with CORESETPoolIndex 0 and 1 respectively). For each CORESET Pool, the same TCI state operation method in terms of activation/deactivation/indication as for described in 2.2-2.4 is assumed.

The other multi-TRP mode, single DCI based multi-TRP, needs two DL TCI states to be associated to one DCI codepoint. That is, when a TCI field codepoint in DCI indicates two TCI states, each TCI state corresponding to a different beam or different TRP. The activation and mapping of 2 TCI states for a codepoint in the TCI field of DCI is done with the MAC CE from 3GPP TS 38.321 shown in FIG. 6.

### Enhanced TCI States Activation/Deactivation for UE-Specific PDSCH MAC CE

The Enhanced TCI States Activation/Deactivation for UE-specific PDSCH MAC CE is identified by a MAC PDU subheader with eLCID as specified in Table 6.2.1-1b. It has a variable size consisting of following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in TS 38.212 [9]. The length of the BWP ID field is 2 bits;
Ci: This field indicates whether the octet containing TCI state IDi,2 is present. If this field is set to “1”, the octet containing TCI state IDi,2 is present. If this field is set to “0”, the octet containing TCI state IDi,2 is not present;
TCI state IDi,j: This field indicates the TCI state identified by TCI-StateId as specified in TS 38.331 [5], where i is the index of the codepoint of the DCI Transmission configuration indication field as specified in TS 38.212 [9] and TCI state IDi,j denotes the jth TCI state indicated for the ith codepoint in the DCI Transmission Configuration Indication field. The TCI codepoint to which the TCI States are mapped is determined by its ordinal position among all the TCI codepoints with sets of TCI state IDi,j fields, i.e., the first TCI codepoint with TCI state ID0,1 and TCI state ID0,2 shall be mapped to the codepoint value 0, the second TCI codepoint with TCI state ID1,1 and TCI state ID1,2 shall be mapped to the codepoint value 1 and so on. The TCI state IDi,2 is optional based on the indication of the Ci field. The maximum number of activated TCI codepoint is 8 and the maximum number of TCI states mapped to a TCI codepoint is 2.

R: Reserved bit, set to “0”.

### Overview of NR Rel-15/Rel-16 TCI State Framework

The NR Rel-15/16 framework for beam management is based on the framework of spatial QCL assumptions and spatial relations to support, e.g., analog beamforming implementations at the UE and/or the network. The framework allows great flexibility for the network (i.e., the gNB) to instruct the UE to receive signals from several directions and to transmit signals in several directions. In this framework, the uplink and downlink configurations are decoupled, e.g., there is no direct relation between the configured spatial QCL assumptions and the spatial relations.

In the Rel-15/Rel-16 framework, downlink beam management is performed by conveying spatial QCL (‘Type D’) assumptions to the UE, which are conveyed in TCI states. One TCI state contains one or two RSs, and each RS is associated with a QCL type.

In the Rel-15/Rel-16 framework, uplink beam management is performed using configuration of spatial relations. A spatial relation is defined at the UE side between a source RS and a target RS. The source RS can be a received DL RS (SSB or CSI-RS) or an SRS. The target RS can be a transmitted PUCCH DMRS or an SRS. Note that there is no direct configuration of the spatial relation for a PUSCH: the PUSCH follows the spatial relation of a PUCCH or an SRS.

Beam Management with Unified TCI Framework in Rel-17

In NR, downlink beam management is performed by conveying spatial QCL (‘Type D’) assumptions to the UE through TCI states.

In NR Rel-15 or Rel-16, for PDCCH, the network (NW) configures the UE with a set of PDCCH TCI states by RRC, and then activates one TCI state per CORESET using MAC CE. For PDSCH beam management, the NW configures the UE with a set of PDSCH TCI states by RRC, and then activates up to 8 TCI states by MAC CE. After activation, the NW dynamically indicates one of these activated TCI states using a TCI field in DCI when scheduling PDSCH.

Such a framework allows great flexibility for the network to instruct the UE to receive signals from different spatial directions in DL with a cost of large signaling overhead and slow beam switch. These limitations are particularly noticeable and costly when UE movement is considered. One example is that beam update using DCI can only be performed for PDSCH, and MAC-CE and/or RRC is required to update the beam for other reference signals/channels, with cause extra overhead and latency.

Furthermore, in majority of cases, the network transmits to and receive from a UE in the same direction for both data and control. Hence, using separate framework (TCI state respective spatial relations) for different channels/signals complicates the implementations.

In Rel-17, a unified TCI state based beam indication framework was introduced to simplify beam management in FR2, in which a common beam represented by a TCI state may be activated/indicated to a UE and the common beam is applicable for multiple channels/signals such as PUCCH and PUSCH. The common beam framework is also referred to a unified TCI state framework.

The new framework can be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels. A TCI state configured under the newly introduced Rel-17 framework will henceforth be referred to as a unified TCI state.

A unified TCI state can be updated in a similar way as the TCI state update for PDSCH in Rel-15/16, i.e., with one of two alternatives:
Two-stage: RRC signaling is used to configure a number unified TCI states in higher layer parameter PDSCH-config, and a MAC-CE is used to activate one of the configured unified TCI states
Three-stage: RRC signaling is used to configure a number unified TCI states in PDSCH-config, a MAC-CE is used to activate up to 8 unified TCI states, and a 3-bit TCI state bitfield in DCI is used to indicate one of the activate unified TCI states

The one activated or indicated unified TCI state will be used in subsequent both PDCCH and PDSCH transmissions until a new unified TCI state is activated or indicated.

The existing DCI formats 1_1 and 1_2 are reused for beam indication (i.e., TCI state indication/update), both with and without DL assignment. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS PDSCH release with both type-1 and type-2 HARQ-ACK codebook is used, where upon a successful reception of the beam indication DCI, the UE reports an ACK.

For DCI-based beam indication, the first slot to apply the indicated TCI state is at least Y symbols after the last symbol of the acknowledgment of the joint or separate DL/UL beam indication. The Y symbols are configured by the gNB based on UE capability, which is also reported in units of symbols. The values of Y are yet not determined and is left to RAN4 to decide.

### UL Transmission to Multiple Transmission Points (TRPs)

PDSCH transmission with multiple transmission points has been introduced in 3GPP for NR Rel-16, in which a transport block may be transmitted over multiple TRPs to improve transmission reliability.

In NR Rel-17, UL enhancement with multiple TRPs is introduced by transmitting a PUSCH towards to different TRPs as shown in FIG. 7 in different times (i.e., PUSCH transmissions to different TRPs are transmitted in time domain multiplexed, TDM, fashion). An example of PUSCH transmission towards multiple TRPs for increasing reliability.

In one scenario, multiple PUSCH transmissions each towards a different TRP may be scheduled by a single DCI. An example of PUSCH repetitions is shown in FIG. 8, where two PUSCH repetitions for a same TB are scheduled by a single DCI, each PUSCH occasion is transmitted towards a different TRP.

In Rel-17, multi-TRP PUSCH, Rel-16 single TRP based type A and type B PUSCH repetitions are extended to two TRPs or two beams. The two beams are mapped to different PUSCH repetitions with either a cyclical mapping pattern or a sequential mapping pattern.

In case of cyclic mapping pattern, the first and second beams are applied to the first and second PUSCH repetitions, respectively, and the same beam mapping pattern continues to the remaining PUSCH repetitions. Cyclic mapping is used in case of two repetitions. For more than 2 repetitions, cyclic mapping is a UE capability.

In case of sequential mapping pattern, the first beam is applied to the first and second PUSCH repetitions, and the second beam is applied to the third and fourth PUSCH repetitions, and the same beam mapping pattern continues to the remaining PUSCH repetitions.

An example is shown in FIG. 9 for cyclic mapping pattern and FIG. 10 for sequential mapping pattern. For Type B PUSCH repetition, the mapping is done based on nominal repetitions.

Both codebook based and non-codebook based PUSCH are supported with multi-TRP PUSCH. Two SRS resource sets are introduced for the purpose. The same number SRS resources should be configured in the two SRS resource sets.

When scheduling PUSCH, two SRS resource indicators (SRIs) are indicated to a UE, each associated one of the two SRS resource sets. For codebook based PUSCH, two Transmit Precoding Matrix Indicators (TPMIs) are also indicated to the UE, each associated one of the two SRS resource sets. For dynamic scheduled PUSCH or type 2 Configured Grants (CGs), the two SRIs and TPMIs are signaled in DCI. For type 1 CG, additional SRI and TPMI fields are included in CG configuration.

For codebook based multi-TRP PUSCH repetition, the number of SRS ports indicated by the two SRIs should be the same.

Dynamic switching between multi-TRP and single-TRP PUSCH operation is supported with a new 2 bit field in DCI as shown in Table 1. The TRP towards which the first PUSCH repetition is transmitted can also be indicated with codepoint “10” for the first TRP or “11” for the second TRP. The new 2 bit field in DCI is referred to as ‘SRS resource set indicator’ field in 3GPP TS 38.212 V17.0.0.

TABLE 1
A new DCI field for dynamic switching between single TRP and multi-TRP PUSCH.

| | | SRI (for both CB and |
|---|---|---|
| Codepoint | SRS resource set(s) | NCB)/TPMI (CB only) field(s) |
| 00 | s-TRP mode with 1^{st} SRS resource set | 1^{st} SRI/TPMI field (2^{nd} field is |
| | (TRP1) | unused) |
| 01 | s-TRP mode with 2^{nd} SRS resource set | 1^{st} SRI/TPMI field (2^{nd} field is |
| | (TRP2) | unused) |
| 10 | m-TRP mode with (TRP1, TRP2 order) | Both 1^{st} and 2^{nd} SRI/TPMI fields |
| | 1^{st} SRI/TPMI field: 1^{st} SRS resource set | |
| | 2^{nd} SRI/TPMI field: 2^{nd} SRS resource set | |
| 11 | m-TRP mode with (TRP2, TRP1 order) | Both 1^{st} and 2^{nd} SRI/TPMI fields |
| | 1^{st} SRI/TPMI field: 1^{st} SRS resource set | |
| | 2^{nd} SRI/TPMI field: 2^{nd} SRS resource set | |

The SRS resource set with lower ID is the first SRS resource set, and the other SRS resource set is the second SRS resource set.

### Association of an SRS Resource Set to a PUSCH Transmission Occasion

When two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, for PUSCH repetition Type A, in case K>1 (where K is the number of repetitions), the same symbol allocation is applied across the K consecutive slots and the PUSCH is limited to a single transmission layer. The UE shall repeat the TB (Transport Block) across the K consecutive slots applying the same symbol allocation in each slot, and the association of the first and second SRS resource set in srs-ResourceSetToAddModList or srs-ResourceSetToAddModListDCI-0-2 to each slot is determined as follows:
if a DCI format 0_1 or DCI format 0_2 indicates codepoint “00” for the SRS resource set indicator, the first SRS resource set is associated with all K consecutive slots,
if a DCI format 0_1 or DCI format 0_2 indicates codepoint “01” for the SRS resource set indicator, the second SRS resource set is associated with all K consecutive slots,
if a DCI format 0_1 or DCI format 0_2 indicates codepoint “10” for the SRS resource set indicator, the first and second SRS resource set association to K consecutive slots is determined as follows:
   When K=2, the first and second SRS resource sets are applied to the first and second slot of 2 consecutive slots, respectively.
   When K>2 and cyclicMapping in PUSCH-Config is enabled, the first and second SRS resource sets are applied to the first and second slot of K consecutive slots, respectively, and the same SRS resource set mapping pattern continues to the remaining slots of K consecutive slots.
   When K>2 and sequentialMapping in PUSCH-Config is enabled, first SRS resource set is applied to the first and second slots of K consecutive slots, and the second SRS resource set is applied to the third and fourth slot of K consecutive slots, and the same SRS resource set mapping pattern continues to the remaining slots of K consecutive slots.
Otherwise, a DCI format 0_1 or DCI format 0_2 indicates codepoint “11” for the SRS resource set indicator, and the first and second SRS resource set association to K consecutive slots is determined as follows,
   When K=2, the second and first SRS resource set are applied to the first and second slot of 2 consecutive slots, respectively.
   When K>2 and cyclicMapping in PUSCH-Config is enabled, the second and first SRS resource sets are applied to the first and second slot of K consecutive slots, respectively, and the same SRS resource set mapping pattern continues to the remaining slots of the K consecutive slots.
   When K>2 and sequentialMapping in PUSCH-Config is enabled, the second SRS resource set is applied to the first and second slot of K consecutive slots, and the first SRS resource set is applied to the third and fourth slot of K consecutive slots, and the same SRS resource set mapping pattern continues to the remaining slots of the K consecutive slots.

For PUSCH repetition Type B, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, the SRS resource set association to nominal PUSCH repetitions follows the same method as SRS resource set association to slots in PUSCH Type A repetition by considering nominal repetitions instead of slots. Improved systems and methods for transmission using activated/indicated TCI states are needed.

### SUMMARY

Systems and methods for implicit associate between multiple Transmission Reception Point (TRP) Physical Uplink Shared Channel (PUSCH) transmission and unified Transmission Configuration Indication (TCI) states are provided. In some embodiments, a method performed by a User Equipment (UE) for transmission using two activated/indicated unified TCI states includes: receiving a configuration comprising: a plurality of unified TCI states; and/or two Sounding Reference Signal (SRS) resource sets to be used for an uplink transmission; receiving a first Downlink Control Information (DCI) that activates/indicates a pair of unified TCI states; and associating a first unified TCI state from the pair of unified TCI states to the first of the two SRS resource sets to be used for an uplink transmission, and associating a second unified TCI state from the pair of unified TCI states to the second of the two SRS resource sets to be used for uplink transmission. In this way, an implicit association is provided between each SRS resource set with an activated/indicated unified TCI state. Thus, the solution makes it possible to extend unified TCI state framework to PUSCH transmission towards multiple TRPs without the need to explicitly configure association parameters. Introducing such explicit configuration parameter for association will increase control signaling overhead which is avoided by the proposed implicit association based solution.

In some embodiments, the method also includes receiving a second DCI that schedules a first uplink transmission and a second uplink transmission associated with the first of the two SRS resource set and the second of the two SRS resource sets, respectively; and transmitting the first uplink transmission according to a first spatial transmit filter derived from the first unified TCI state, and transmitting the second uplink transmission according to a second spatial transmit filter derived from the second unified TCI state.

In some embodiments, the first uplink transmission is a first Physical Uplink Shared Channel, PUSCH, transmission and the second uplink transmission is a second PUSCH transmission.

In some embodiments, receiving the configuration comprises receiving the configuration via Radio Resource Control, RRC.

In some embodiments, the PUSCH transmission(s)/repetition(s) associated with the first configured SRS resource set are transmitted using transmit spatial filter indicated by the first activated/indicated unified TCI state.

In some embodiments, the transmit power for the PUSCH transmission(s)/repetition(s) associated with the first configured SRS resource set is calculated according to a set of power control parameters associated with the first activated/indicated unified TCI state.

In some embodiments, the PUSCH transmission(s)/repetition(s) associated with the second configured SRS resource set are transmitted using transmit spatial filter indicated by the second activated/indicated unified TCI state.

In some embodiments, the transmit power for the PUSCH transmission(s)/repetition(s) associated with the second configured SRS resource set is calculated according to a set of power control parameters associated with the second activated/indicated unified TCI state.

Certain aspects of the disclosure and their embodiments may provide solutions to these or other challenges. Some embodiments of this disclosure enable the use of the unified TCI framework to be used for PUSCH transmission towards multiple TRPs. The specific solutions are based on implicitly associating a first SRS resource set configured for codebook-based or non-codebook based PUSCH transmission with a first activated/indicated unified TCI state, and a second SRS resource set configured for codebook-based or non-codebook based PUSCH transmission with a second activated/indicated unified TCI state.

A method at the UE for PUSCH transmission using two activated/indicated unified TCT states, the method comprising one or more of: receiving (RRC) configuration from the network of (1) a plurality of unified TCI states, and (2) two SRS resource sets to be used for PUSCH transmission; receiving a first DCI that activates/indicates a pair of unified TCI states; associating a first unified TCI state from the pair of unified TCI states to the first of the two SRS resource sets to be used for PUSCH transmission, and associating a second unified TCI state from the pair of unified TCI states to the second of the two SRS resource sets to be used for PUSCH transmission; receiving a second DCI that schedules a first PUSCH transmission and a second PUSCH transmission associated with the first of the two SRS resource set and the second of the two SRS resource sets, respectively; transmitting the first PUSCH transmission according to a first spatial transmit filter derived from the first unified TCI state, and transmitting the second PUSCH transmission according to a second spatial transmit filter derived from the second unified TCI state.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in New Radio (NR) is typically in slot basis with a 14-symbol slot, where the first two symbols contain physical downlink control channel (PDCCH) and the rest contains physical shared data channel (PDCH), either physical downlink shared channel (PDSCH) or physical uplink shared channel (PUSCH);

FIG. 2 illustrates a basic NR physical time-frequency resource grid where only one resource block (RB) within a 14-symbol slot is shown;

FIG. 3 illustrates a two-step procedure related to Transmission Configuration Indication (TCI) state update;

FIG. 4 illustrates a structure of the Medium Access Control (MAC) Control Element (CE) for activating/deactivating TCI states for UE specific PDSCH;

FIG. 5 illustrates one example of a Downlink Control Information (DCI) indication to indicate to the UE that it shall use one of the activated TCI states for the subsequent PDSCH reception;

FIG. 6 illustrates the activation and mapping of two TCI states for a codepoint in the TCI field of DCI is done with the MAC CE from 3GPP TS 38.321;

FIG. 7 illustrates, in NR Rel-17, uplink (UL) enhancement with multiple transmission reception points (TRPs) is introduced by transmitting a PUSCH towards to different TRPs in different times;

FIG. 8 illustrates an example of PUSCH repetitions;

FIG. 9 illustrates a cyclic mapping pattern;

FIG. 10 illustrates a sequential mapping pattern;

FIG. 11A illustrates an example depicting association of a unified TCI state with an SRS resource set, according to some embodiments of the current disclosure;

FIG. 11B illustrates a method performed by a UE for transmission using two activated/indicated unified TCI states, according to some embodiments of the current disclosure;

FIG. 12A illustrates both SRS resource sets are indicated by the SRS resource indicator field in DCI₂, according to some embodiments of the current disclosure;

FIG. 12B illustrates both SRS resource sets are indicated by the SRS resource set indicator field in DCI₁, according to some embodiments of the current disclosure;

FIG. 12C, only the first SRS resource set is indicated by the SRS resource indicator field in DCI₁, so both the first and second PUSCH transmission occasions are transmitted according to the first activated/indicated unified TCI state, according to some embodiments of the current disclosure;

FIG. 13 illustrates a second example embodiment depicting association of a unified TCI state with an SRS resource set, according to some embodiments of the current disclosure;

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host, which may be an embodiment of the host of FIG. 14, in accordance with various aspects described herein;

FIG. 18 is a block diagram illustrating a virtualization environment in which functions implemented by some embodiments may be virtualized; and

FIG. 19 shows a communication diagram of a host communicating via a network node with a UE over a partially wireless connection in accordance with some embodiments.

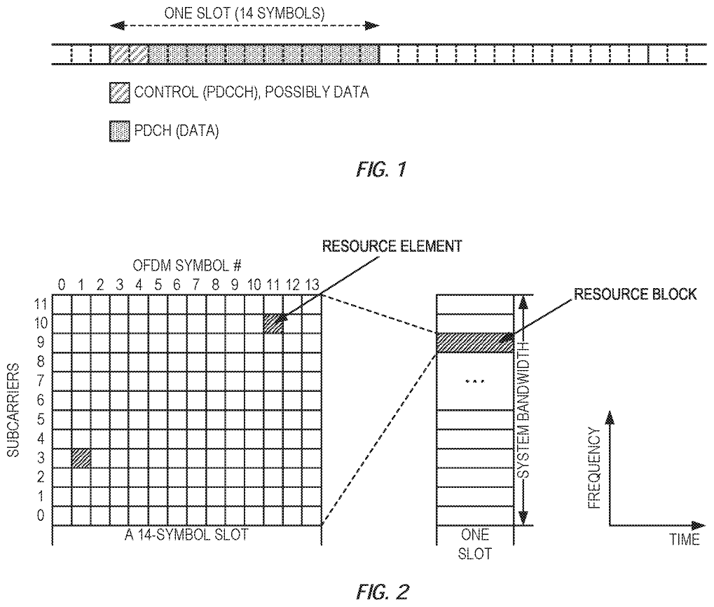

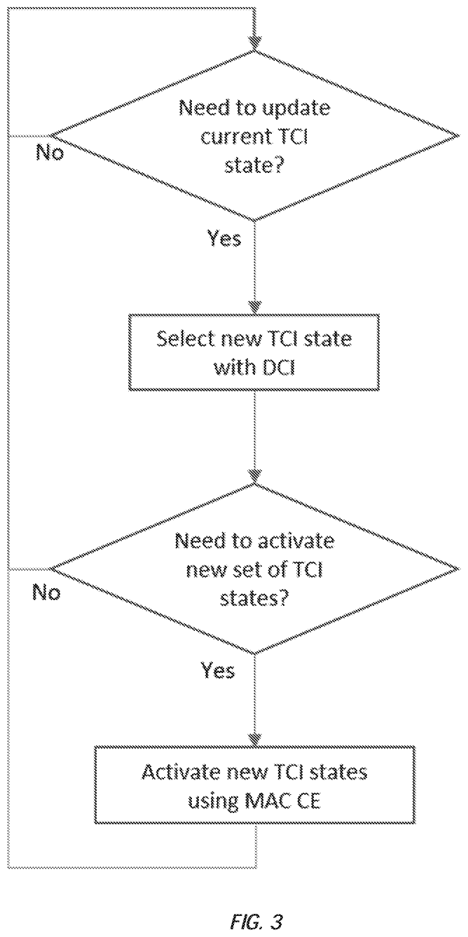

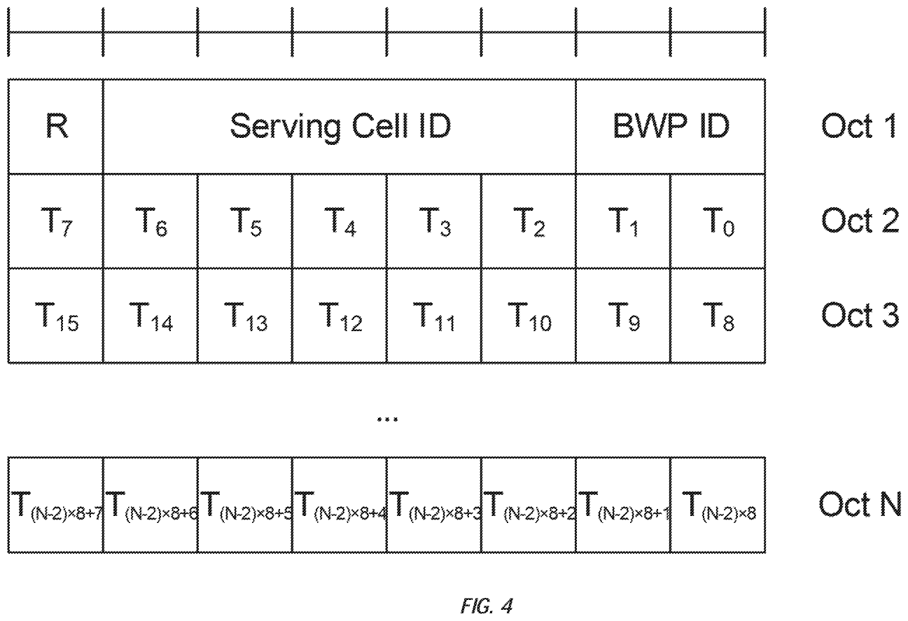

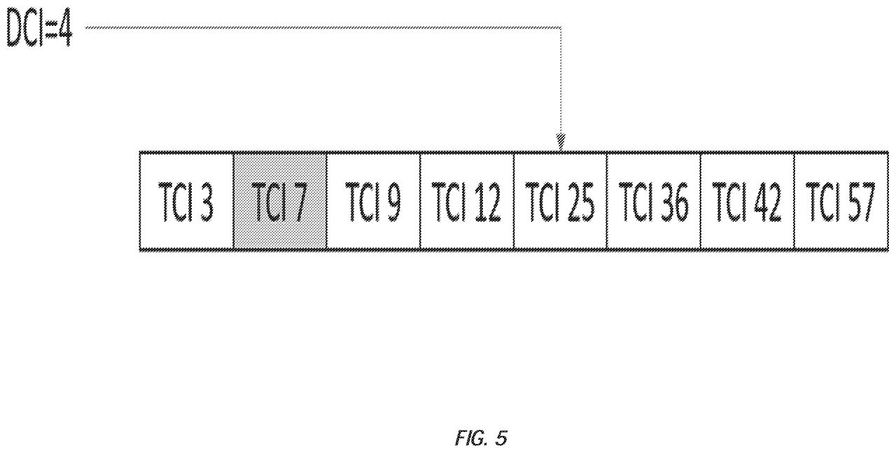

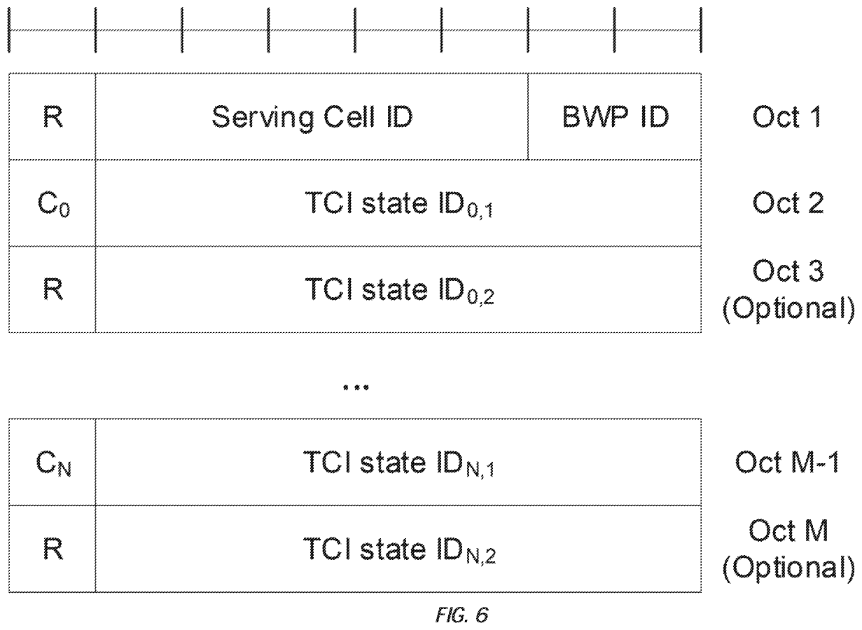

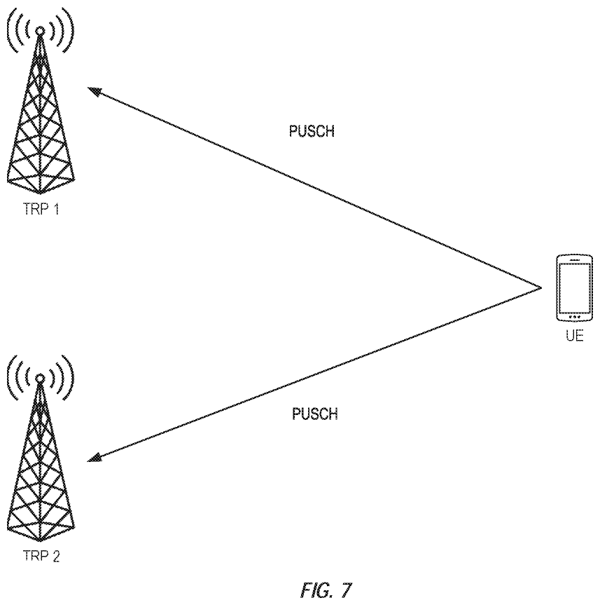

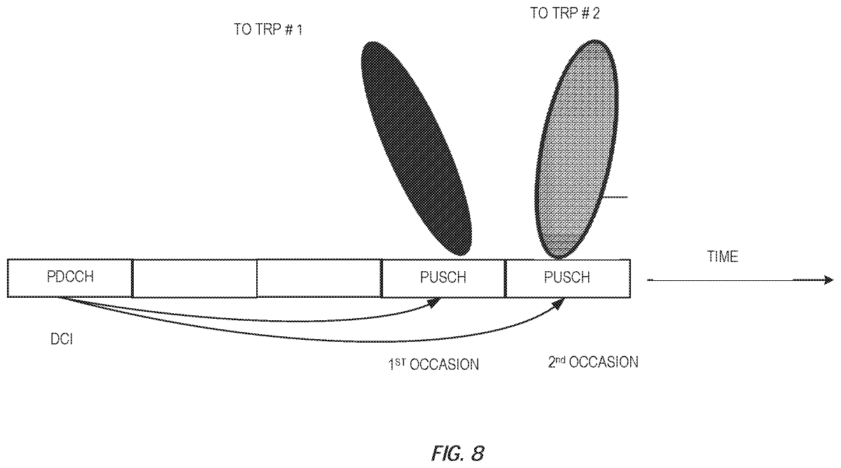

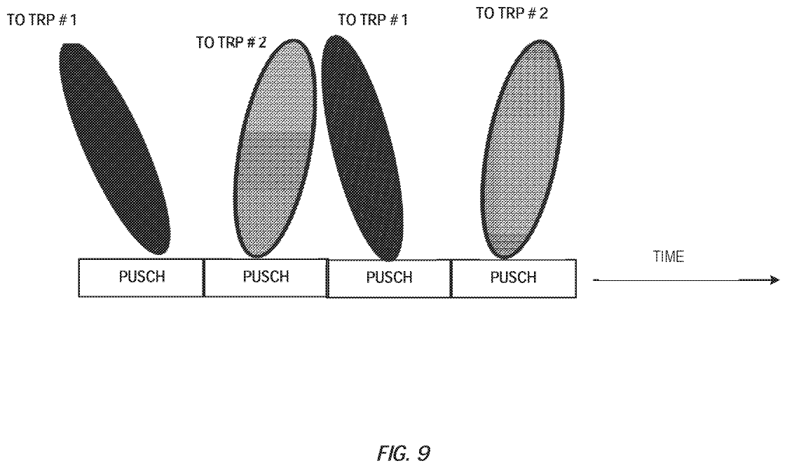

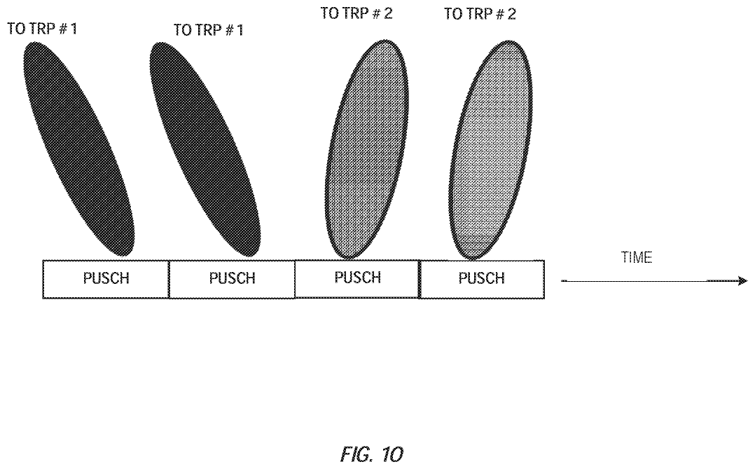

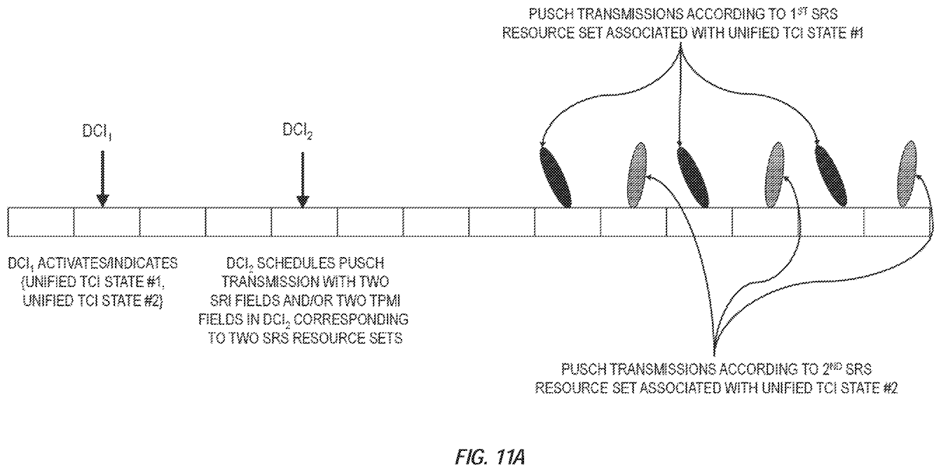

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In 3GPP up to Release-17, PUSCH transmission using unified TCI state is only supported for PUSCH transmission targeting a single TRP. PUSCH transmission targeting multiple TRPs is only supported using the old spatial relation-based framework and not supported using unified TCI state based framework. Hence, how to support PUSCH transmission targeting multiple TRPs using unified TCI based framework is an open problem.

Certain aspects of the disclosure and their embodiments may provide solutions to these or other challenges. Some embodiments of this disclosure enable the use of the unified TCI framework to be used for PUSCH transmission towards multiple TRPs. The specific solutions are based on implicitly associating a first SRS resource set configured for codebook-based or non-codebook based PUSCH transmission with a first activated/indicated unified TCI state, and a second SRS resource set configured for codebook-based or non-codebook based PUSCH transmission with a second activated/indicated unified TCI state.

A method at the UE for PUSCH transmission using two activated/indicated unified TCI states, the method comprising one or more of: receiving (RRC) configuration from the network of (1) a plurality of unified TCI states, and (2) two SRS resource sets to be used for PUSCH transmission; receiving a first DCI that activates/indicates a pair of unified TCI states; associating a first unified TCI state from the pair of unified TCI states to the first of the two SRS resource sets to be used for PUSCH transmission, and associating a second unified TCI state from the pair of unified TCI states to the second of the two SRS resource sets to be used for PUSCH transmission; receiving a second DCI that schedules a first PUSCH transmission and a second PUSCH transmission associated with the first of the two SRS resource set and the second of the two SRS resource sets, respectively; transmitting the first PUSCH transmission according to a first spatial transmit filter derived from the first unified TCI state, and transmitting the second PUSCH transmission according to a second spatial transmit filter derived from the second unified TCI state.

Certain embodiments may provide one or more of the following technical advantage(s). The solution proposed here provides an implicit association between each SRS resource set with an activated/indicated unified TCI state. Thus, the solution makes it possible to extend unified TCI state framework to PUSCH transmission towards multiple TRPs without the need to explicitly configure association parameters. Introducing such explicit configuration parameter for association will increase control signaling overhead which is avoided by the proposed implicit association based solution.

In the rest of the disclosure, it is assumed that the term TRP may not be captured in 3GPP specifications. In the various embodiments disclosed, a TRP may be represented by at least one of the following:
a Unified TCI state as defined above (which can be either a Joint DL/UL TCI state or an UL TCI state)
an SRS resource set with usage set to either ‘codebook’ based PUSCH transmission or ‘nonCodebook’ based PUSCH transmission
a DCI field that indicates at least one SRS resource indicator (e.g., an SRI field in UL DCI)
a DCI field that indicates a transmit precoder matrix indicator, TPMI, to be used by UE for PUSCH transmission (e.g., a Precoding Information field in UL DCI). In some cases, Precoding Information field in UL DCI may also indicate the number of layers corresponding to the PUSCH transmission).

In a general embodiment, when the UE is configured with two SRS resource sets with usage set to either ‘codebook’ based PUSCH or ‘nonCodebook’ based PUSCH and two unified TCI states are activated/indicated using the unified TCI framework, then each SRS resource set is associated with only one of the two activated/indicated unified TCI states. For instance, the first configured SRS resource set is associated with the first activated/indicated unified TCI state, and the second configured SRS resource set is associated with the second activated/indicated unified TCI state. Hence, in this embodiment:

The PUSCH transmission(s)/repetition(s) associated with the first configured SRS resource set are transmitted using transmit spatial filter (i.e., transmit beam) indicated by the first activated/indicated unified TCI state; in some cases, the transmit power for the PUSCH transmission(s)/repetition(s) associated with the first configured SRS resource set is calculated according to a set of power control parameters associated with the first activated/indicated unified TCI state; and

The PUSCH transmission(s)/repetition(s) associated with the second configured SRS resource set are transmitted using transmit spatial filter (i.e., transmit beam) indicated by the second activated/indicated unified TCI state; in some cases, the transmit power for the PUSCH transmission(s)/repetition(s) associated with the second configured SRS resource set is calculated according to a set of power control parameters associated with the second activated/indicated unified TCI state.

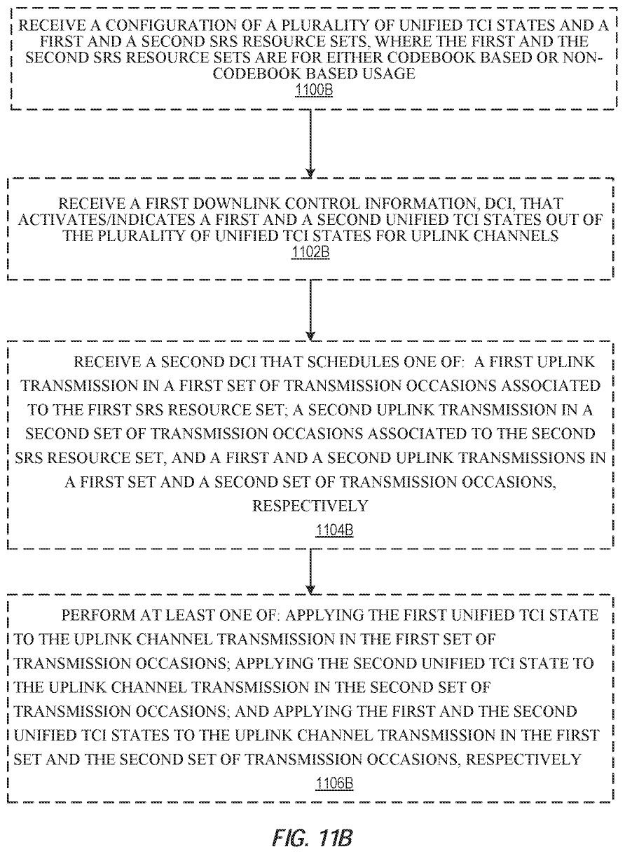

A more detailed example embodiment is shown in FIG. 11A which is an example depicting association of a unified TCI state with an SRS resource set. The rectangles shown in the figure represent either a slot or a subslot (e.g., a set of consecutive symbols). FIG. 11B illustrates a method performed by a UE for transmission using two activated/indicated unified TCI states, according to some embodiments of the current disclosure. Some embodiments include one or more of: receiving (1100B) a configuration of a plurality of unified TCI states and a first and a second SRS resource sets, where the first and the second SRS resource sets are for either codebook based or non-codebook based usage; receiving (1102B) a first DCI that activates/indicates a first and a second unified TCI states out of the plurality of unified TCI states for uplink channels; receiving (1104B) a second DCI; and performing (1106B) at least one of: applying the first unified TCI state to the uplink channel transmission in the first set of transmission occasions; applying the second unified TCI state to the uplink channel transmission in the second set of transmission occasions; and applying the first and the second unified TCI states to the uplink channel transmission in the first set and the second set of transmission occasions, respectively.

The steps involved in this example embodiment are described below:

Step 1: UE receives DCI₁ which activates/indicates a pair of unified TCI states. In some embodiments, DCI₁ is a DL DCI (e.g., DCI format 1_1, DCI format 1_2) which may or may not schedule a PDSCH. The two unified TCI states {Unified TCI state #1, Unified TCI state #2} may be activated via a TCI field codepoint in DCI₁ where the codepoint is mapped to identifiers of Unified TCI state #1 and Unified TCI state #2.

Step 2: After a pre-configured or specified period of time, the UE receives DCI₂ which schedules PUSCH transmission associated to two SRS resource sets which were previously configured to the UE by the gNB. The pre-configured or specified period of time is the time needed for the activated/indicated unified TCI states to be applied for subsequent transmissions by the UE. In one embodiment, DCI₂ contains an SRS resource set indicator field, and two SRI fields and/or two TPMI fields. The SRS resource set indicator can for example indicate whether the PUSCH transmission is associated with the first SRS resource set, the 2^{nd} SRS resource set, or both the first and second SRS resource set. Assuming the PUSCH transmissions associated with the first and second SRS resource sets are time division multiplexed (as shown in FIG. 11A), and that the PUSCH transmission scheduled by DCI₂ is associated with both the SRS resource sets, the SRS resource set indicator also indicates whether a first PUSCH transmission instance in time is associated with the 1^{st} or 2^{nd} SRS resource set. The first SRI field corresponds to the first SRS resource set, and the second SRI field corresponds to the second SRS resource set. Similarly, the first TPMI field corresponds to the first SRS resource set, and the second TPMI field corresponds to the second SRS resource set. The PUSCH transmission scheduled by DCI₂ can either be a dynamically scheduled PUSCH (i.e., dynamic-grant PUSCH) transmission or a semi-persistently scheduled PUSCH of configured grant type 2. For configured grant type 1 based PUSCH which is semi-statically configured by RRC, the associated SRS resource sets are RRC configured.

Step 3: In one embodiment, the UE associates the first SRS resource set with the first activated/indicated unified TCI state (e.g., Unified TCI state #1), and associates the second SRS resource set with the second activated/indicated unified TCI state (e.g., Unified TCI state #2). In some embodiments, the first SRS resource set is the SRS resource set with lower SRS resource set ID (i.e., lower “srs-ResourceSetId” as specified in TS 38.331) out of the two SRS resource sets configured with usage ‘codebook’ or ‘nonCodebook’ (i.e., this means the second SRS resource set is the SRS resource set with higher SRS resource set ID out of the two SRS resource sets configured with usage ‘codebook’ or ‘nonCodebook’). In another embodiment, the UE associates the first SRI field in DCI₂ with the first activated/indicated unified TCI state (e.g., Unified TCI state #1), and associates the second SRI field in DCI₂ with the second activated/indicated unified TCI state (e.g., Unified TCI state #2). In yet another embodiment, the UE associates the first TPMI field in DCI₂ with the first activated/indicated unified TCI state (e.g., Unified TCI state #1), and associates the second TPMI field in DCI₂ with the second activated/indicated unified TCI state (e.g., Unified TCI state #2). In some embodiments, the first activated/indicated unified TCI state is the unified TCI state among the two activated/indicated unified TCI states with the lower TCI state ID, and the second activated/indicated unified TCI state is the unified TCI state among the two activated/indicated unified TCI states with the higher TCI state ID. In another embodiment, the first activated/indicated unified TCI state is the first unified TCI state mapped to the TCI field codepoint in DCI₁, and the second activated/indicated unified TCI state is the second unified TCI state mapped to the TCI field codepoint in DCI₁.

Step 4: In one embodiment, a first set of PUSCH transmissions (e.g., a first set of PUSCH transmission occasions/repetitions in a first subset of slots or symbols within a slot) scheduled by DCI₂ are transmitted over the same ports as the SRS transmissions in SRS resource(s) indicated by the first SRI field in DCI₂. In some embodiments, if a single SRS resource is configured in the first SRS resource set (i.e., the first SRI field is not present in DCI₂), then the first set of PUSCH transmissions scheduled by DCI₂ are transmitted over the same ports as the SRS transmission in the SRS resource configured in the first SRS resource set. In these embodiments, the first set of PUSCH transmissions are performed by the UE according to the spatial relation source RS provided by the first activated/indicated unified TCI state (e.g., Unified TCI state #1). That is, the UE determines the spatial transmit filter for transmitting the first set of PUSCH transmissions using the source RS with QCL type D in the first activated/indicated unified TCI state. In another embodiment, the first set of PUSCH transmissions are transmitted using the transmit precoder matrix indicated by the first TPMI field in DCI₂.

A second set of PUSCH transmissions (e.g., a second set of PUSCH transmission occasions/repetitions in a second subset of slots or symbols within a slot) scheduled by DCI₂ are transmitted over the same ports as the SRS transmissions in SRS resource(s) indicated by the second SRI field in DCI₂. In some embodiments, if a single SRS resource is configured in the second SRS resource set (i.e., the second SRI field is not present in DCI₂), then the second set of PUSCH transmissions scheduled by DCI₂ are transmitted over the same ports as the SRS transmission in the SRS resource configured in the second SRS resource set. In these embodiments, the second set of PUSCH transmissions are performed by the UE according to the spatial relation source RS provided by the second activated/indicated unified TCI state (e.g., Unified TCI state #2). That is, the UE determines the spatial transmit filter for transmitting the second set of PUSCH transmissions using the source RS with QCL type D in the second activated/indicated unified TCI state. In another embodiment, the second set of PUSCH transmissions are transmitted using the transmit precoder matrix indicated by the second TPMI field in DCI₂.

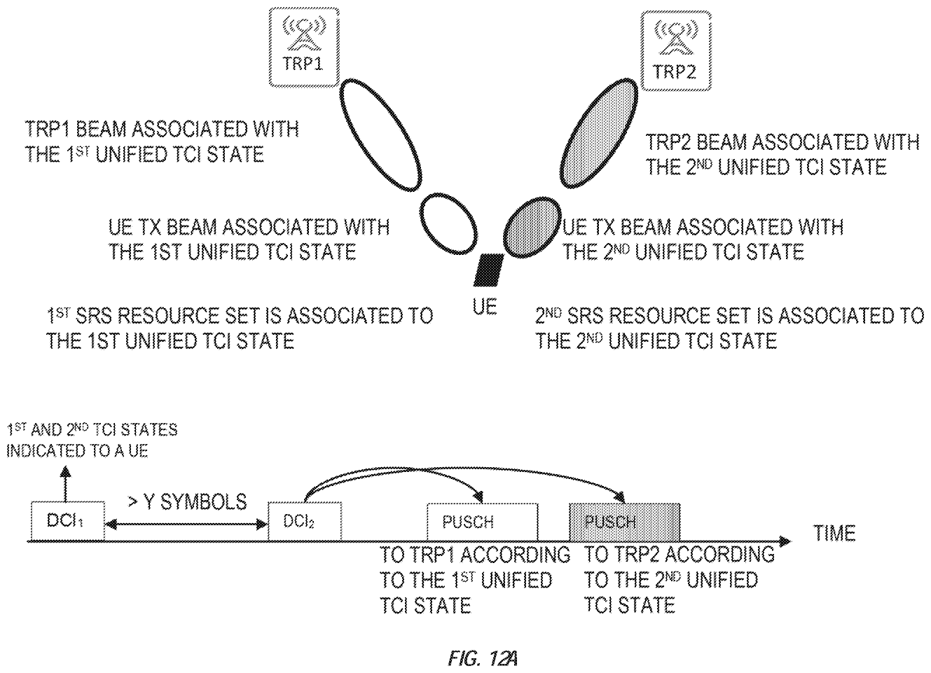

In a further embodiment, PUSCH repetitions or transmission occasions associated with the first SRS resource set are transmitted according to the first unified TCI state, and PUSCH repetitions or transmission occasions associated with the second SRS resource set are transmitted according to the second unified TCI state. The association between a PUSCH transmission occasion and an SRS resource set is determined by a combination of the SRS resource set indicator field in DCI, the number of PUSCH repetitions, and either cyclicMapping or sequentialMapping configured in PUSCH-Config. An example with two PUSCH repetitions is shown in FIGS. 12A through 12C, where DCI₂ is received at least Y symbols after the first and second unified TCI states being activated/indicated via DCI. The SRS resource set indicator field in DCI₂ indicates the SRS resource set(s) associated with the PUSCH transmission scheduled by the DCL In FIG. 12A, both SRS resource sets are indicated by the SRS resource indicator field in DCI₂; the first SRS resource set is associated with first PUSCH transmission occasion and the second SRS resource set is associated with the second PUSCH transmission occasion. Since the first and second SRS resource sets are associated with the first and second activated/indicated unified TCI states, respectively, the first PUSCH transmission occasion is transmitted according to the first unified TCI state and the second PUSCH transmission occasion is transmitted according to the second unified TCI state. Similarly, in FIG. 12B, both SRS resource sets are indicated by the SRS resource set indicator field in DCI; the second SRS resource set is associated with first PUSCH transmission occasion in this case, and the first SRS resource set is associated with the second PUSCH transmission occasion. Therefore, the first PUSCH transmission occasion is transmitted according to the second activated/indicated unified TCI state and the second PUSCH transmission occasion is transmitted according to the first activated/indicated unified TCI state. In FIG. 12C, only the first SRS resource set is indicated by the SRS resource indicator field in DCI₁, so both the first and second PUSCH transmission occasions are transmitted according to the first activated/indicated unified TCI state.

In one embodiment, a first set of PUSCH transmissions (e.g., a first set of PUSCH transmission occasions/repetitions in a first subset of slots or symbols within a slot) scheduled by DCI₂ are transmitted over the same ports as the SRS transmissions in SRS resource(s) in the SRS resource set indicated by the SRS resource set indicator field in DCI₂ and the associated SRI field in DCI₂. For example, in case the SRS resource set indicator field indicates that a first set of PUSCH transmissions are associated with the 2^{nd} SRS resource set, the second SRI field in DCI₂ is used to indicate which of the SRS resources belonging to the 2^{nd} SRS resource set that the PUSCH transmission should be associated with. In some embodiments, if a single SRS resource is configured in the SRS resource set indicated by the SRS resource set indicator field in DCI₂ (i.e., no SRI field is present in DCI₂ for the indicated SRS resource set), then the first set of PUSCH transmissions scheduled by DCI₂ are transmitted over the same ports as the SRS transmission in the SRS resource configured in the SRS resource set indicated by the SRS resource set indicator field. In these embodiments, in case the SRS resource set indicator field indicates a first SRS resource set for a first set of PUSCH transmissions, the first set of PUSCH transmissions are performed by the UE according to the spatial relation source RS provided by the first activated/indicated unified TCI state (e.g., Unified TCI state #1). That is, the UE determines the spatial transmit filter for transmitting the first set of PUSCH transmissions using the source RS with QCL type D in the first activated/indicated unified TCI state. And in case the resource set indicator field indicates a second SRS resource set for a first set of PUSCH transmissions, the first set of PUSCH transmissions are performed by the UE according to the spatial relation source RS provided by the second activated/indicated unified TCI state (e.g., Unified TCI state #1). That is, the UE determines the spatial transmit filter for transmitting the first set of PUSCH transmissions using the source RS with QCL type D in the second activated/indicated unified TCI state. In another embodiment, the first set of PUSCH transmissions are transmitted using the transmit precoder matrix indicated by the first TPMI field in DCI₂ in case the SRS resource set indicator field indicates a first SRS resource set for the first set of PUSCH transmissions, and the first set of PUSCH transmissions are transmitted using the transmit precoder matrix indicated by the second TPMI field in DCI₂ in case the SRS resource set indicator field indicates a second SRS resource set for the first set of PUSCH transmissions.

In an optional embodiment, in case the PUSCH transmission is associate with both the first and the second SRS resource set, the resource set indicator field also indicates if the same or different payload should be transmitted over the first PUSCH transmission instance and the second PUSCH transmission indication. For example, in case the same frequency and time allocation is indicated for the first and second PUSCH transmission instances, the resource set indicator field can either indicate different payloads/layers for the first and second PUSCH transmission instances (spatial multiplexing) or the same payload/layers for the first and second PUSCH transmission instances (single frequency network transmission).

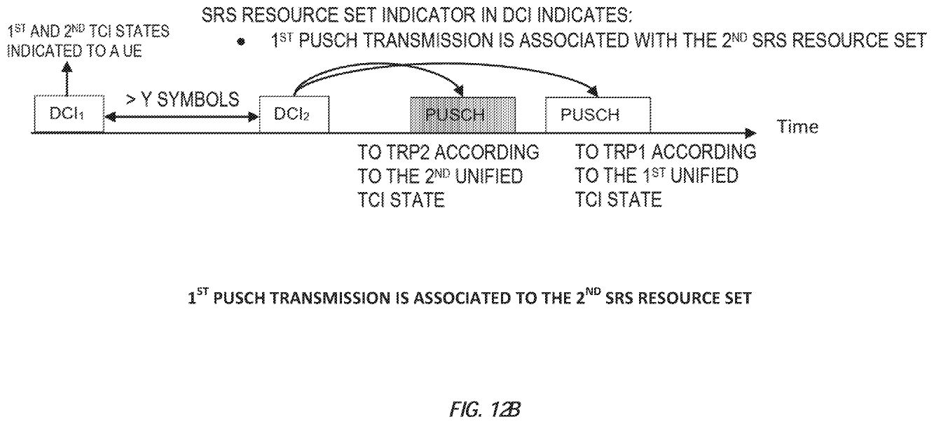

A second example embodiment is shown in FIG. 13. The rectangles shown in the figure represent either a slot or a subslot (e.g., a set of consecutive symbols). The steps involved in this example embodiment are described below:

Step 1: UE receives DCI₁ which activates/indicates a pair of unified TCI states. In some embodiments, DCI₁ is a DL DCI (e.g., DCI format 1_1, DCI format 1_2) which may or may not schedule a PDSCH. The two unified TCI states {Unified TCI state #1, Unified TCI state #2} may be activated via indicating a TCI field codepoint in DCI₁ where the TCI codepoint is mapped to identifiers of Unified TCI state #1 and Unified TCI state #2.

Step 2: after a pre-configured or specified period of time, the UE receives DCI₂ which schedules PUSCH transmissions to be simultaneously transmitted in the same time domain symbols by the UE. The PUSCH transmissions correspond to two SRS resource sets which were previously configured to the UE by the gNB. In one embodiment, DCI₂ contains an SRS resource set indicator field, and two SRI fields and/or two TPMI fields. The SRS resource set indicator field indicates whether the PUSCH transmission is associated with the first SRS resource set, the second SRS resource set, or both the first and second SRS resource set. In case that the PUSCH transmission is associated with both the SRS resource sets, the SRS resource set indicator also indicates whether a first PUSCH transmission instance in time is associated with the 1^{st} or 2^{nd} SRS resource set. The first SRI field corresponds to the first SRS resource set, and the second SRI field corresponds to the second SRS resource set. Similarly, the first TPMI field corresponds to the first SRS resource set, and the second TPMI field corresponds to the second SRS resource set. The PUSCH transmissions scheduled by DCI2 can either be a dynamically scheduled PUSCH (i.e., dynamic-grant PUSCH) transmission or a semi-persistently scheduled PUSCH using configured grant type 2. For configured grant type 1 based PUSCH which is semi-statically configured by RRC, the associated SRS resource sets are RRC configured.

Step 3: In one embodiment, the UE associates the first SRS resource set with the first activated/indicated unified TCI state (e.g., Unified TCI state #1), and associates the second SRS resource set with the second activated/indicated unified TCI state (e.g., Unified TCI state #2). In another embodiment, the UE associates the first SRI field in DCI₂ with the first activated/indicated unified TCI state (e.g., Unified TCI state #1), and associates the second SRI field in DCI₂ with the second activated/indicated unified TCI state (e.g., Unified TCI state #2). In yet another embodiment, the UE associates the first TPMI field in DCI₂ with the first activated/indicated unified TCI state (e.g., Unified TCI state #1), and associates the second TPMI field in DCI₂ with the second activated/indicated unified TCI state (e.g., Unified TCI state #2).

Step 4: In one embodiment, a first PUSCH transmission (e.g., a first PUSCH transmission occasion) scheduled by DCI₂ is transmitted over the same ports as the SRS transmissions in SRS resource(s) indicated by the first SRI field in DCI₂. In some embodiments, if a single SRS resource is configured in the first SRS resource set (i.e., the first SRI field is not present in DCI₂), then the first PUSCH transmission scheduled by DCI₂ is transmitted over the same ports as the SRS transmission in the SRS resource configured in the first SRS resource set. In these embodiments, the first PUSCH transmission is performed by the UE according to the spatial relation source RS provided by the first activated/indicated unified TCI state (e.g., Unified TCI state #1). That is, the UE determines the spatial transmit filter for transmitting the first PUSCH transmission using the source RS with QCL type D in the first activated/indicated unified TCI state.

The second PUSCH transmission (e.g., a second PUSCH transmission occasion which is made in overlapping symbols used to transmit the first PUSCH transmission) scheduled by DCI₂ is transmitted over the same ports as the SRS transmissions in SRS resource(s) indicated by the second SRI field in DCI₂. In some embodiments, if a single SRS resource is configured in the second SRS resource set (i.e., the second SRI field is not present in DCI₂), then the second PUSCH transmission scheduled by DCI₂ is transmitted over the same ports as the SRS transmission in the SRS resource configured in the second SRS resource set. In these embodiments, the second PUSCH transmission is performed by the UE according to the spatial relation source RS provided by the second activated/indicated unified TCI state (e.g., Unified TCI state #2). That is, the UE determines the spatial transmit filter for transmitting the second PUSCH transmission using the source RS with QCL type D in the second activated/indicated unified TCI state. In another embodiment, the second PUSCH transmission is transmitted using the transmit precoder matrix indicated by the second TPMI field in DCI₂.

In another embodiment, the first PUSCH transmission is transmitted using the transmit precoder matrix indicated by the first TPMI field in DCI₂. In a further embodiment, PUSCH repetitions or transmission occasions associated with the first SRS resource set are transmitted according to the first unified TCI state, and PUSCH repetitions or transmission occasions associated with the second SRS resource set are transmitted according to the second unified TCI state. The association between a PUSCH transmission occasion and an SRS resource set is determined by a combination of the SRS resource set indicator in DCI, the number of PUSCH repetitions, and either cyclicMapping or sequentialMapping configured in PUSCH-Config.

In some embodiments, the two PUSCH transmissions shown in FIG. 13 are two sets of PUSCH layers transmitted by the UE wherein the two sets of PUSCH layers belong to a single PUSCH. The single PUSCH in this case is scheduled/triggered by a single DCI (DCI₂) as shown in the figure, and the two sets of PUSCH layers are transmitted simultaneously in STxMP (simultaneous transmission across multiple panels) fashion. The spatial transmit filters used for transmitting PUSCH layer set 1 and PUSCH layer set 2 are determined as described in Steps 4 and 5 above, respectively. In one example, the two sets of PUSCH layers carry different layers that correspond to the same TB or CW. In another example, the two sets of PUSCH layers carry different layers that correspond to different TBs or CWs (e.g., PUSCH layer 1 in PUSCH layer set 1 corresponds to a first TB or CW, and PUSCH layer 2 in PUSCH layer set 2 corresponds to a second TB or CW). In these embodiments, the two PUSCH layer sets transmitted in STxMP fashion fully overlapping in time and frequency domain (i.e., two PUSCH layer sets are transmitted in same set of time and frequency resources).

In some embodiments, the two PUSCH transmissions shown in FIG. 13 are two PUSCHs transmitted by the UE towards to two TRPs. In one example, the two PUSCHs are two PUSCH repetitions (which are transmitted in at least partly overlapping symbols in the time domain) that carry the same transport block (TB) or same codeword (CW). In another example, the two PUSCHs are transmitted in at least partly overlapping symbols in the time domain wherein each PUSCH carries a different TB or CW. The two PUSCHs in these embodiments are transmitted using two transmit spatial filters. The two transmit spatial filters may be derived by the UE as described in Steps 4 and 5 above. In some embodiments, the two PUSCHs transmitted in STxMP fashion as shown in FIG. 13 may be: non-overlapping in frequency domain (i.e., two PUSCHs are transmitted in different RBs); partially overlapping in frequency domain (i.e., a subset of the RBs used for transmitting the two PUSCHs are common while the other set of RBs excluding the subset of RBs used for transmitting the two PUSCHs are different); or fully overlapping in frequency domain (i.e., two PUSCHs are transmitted in same set of RBs).

In the embodiments in FIG. 11A and FIG. 13, each unified TCI state can be either a Joint DL/UL TCI state or a UL-only TCI state.

In one embodiment, in case the UE is configured with two SRS resource sets with usage ‘codebook’ or ‘nonCodebook’, and the UE receives DCI1 which activates/indicates a pair of unified TCI states, both these SRS resource sets should be activated for transmission, i.e., the UE should transmit both the SRS resource sets when configured/triggered to do so. In case the UE is configured with two SRS resource sets with usage ‘codebook’ or ‘nonCodebook’, and the UE receives DCI1 which activates/indicates a single unified TCI state, one of these SRS resource sets should be inactivated for transmission, i.e., the UE should only transmit one of the two SRS resource sets even if the UE is configured/triggered to transmit both of them. In one alternate of this embodiment, in case the UE receives DCI1 which activates/indicates a single first unified TCI state, the first SRS resource set with usage ‘codebook’ or ‘nonCodebook’ should be inactivated, and in case the UE receives DCI1 which activates/indicates a single second unified TCI state, the second SRS resource set with usage ‘codebook’ or ‘nonCodebook’ should be inactivated.

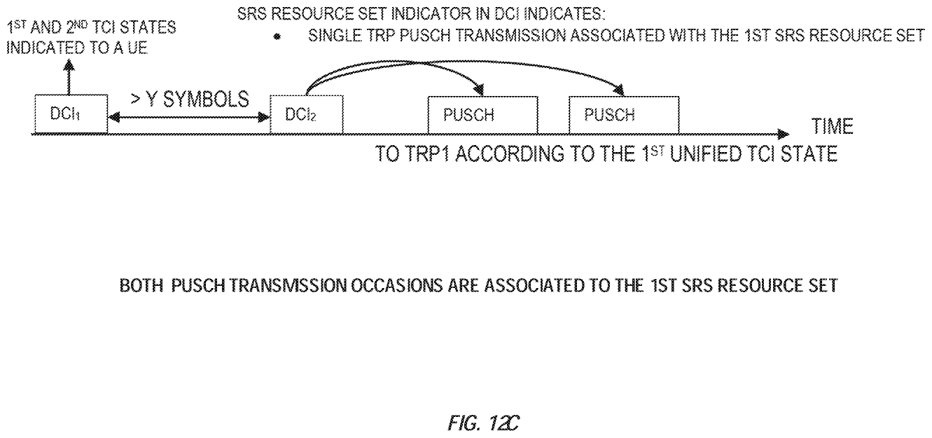

FIG. 14 shows an example of a communication system 1400 in accordance with some embodiments.

In the example, the communication system 1400 includes a telecommunication network 1402 that includes an access network 1404, such as a Radio Access Network (RAN), and a core network 1406, which includes one or more core network nodes 1408. The access network 1404 includes one or more access network nodes, such as network nodes 1410A and 1410B (one or more of which may be generally referred to as network nodes 1410), or any other similar Third Generation Partnership Project (3GPP) access node or non-3GPP Access Point (AP). The network nodes 1410 facilitate direct or indirect connection of User Equipment (UE), such as by connecting UEs 1412A, 1412B, 1412C, and 1412D (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system 1400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1402 is a cellular network that implements 3GPP standardized features. Accordingly, the telecommunication network 1402 may support network slicing to provide different logical networks to different devices that are connected to the telecommunication network 1402. For example, the telecommunication network 1402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR—Dual Connectivity (EN-DC).

In the example, a hub 1414 communicates with the access network 1404 to facilitate indirect communication between one or more UEs (e.g., UE 1412C and/or 1412D) and network nodes (e.g., network node 1410B). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a Virtual Reality (VR) headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410B. The hub 1414 may also allow for a different communication scheme and/or schedule between the hub 1414 and UEs (e.g., UE 1412C and/or 1412D), and between the hub 1414 and the core network 1406. In other examples, the hub 1414 is connected to the core network 1406 and/or one or more UEs via a wired connection. Moreover, the hub 1414 may be configured to connect to a Machine-to-Machine (M2M) service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410B. In other embodiments, the hub 1414 may be a non-dedicated hub—that is, a device which is capable of operating to route communications between the UEs and the network node 1410B, but which is additionally capable of operating as a communication start and/or end point for certain data channels.

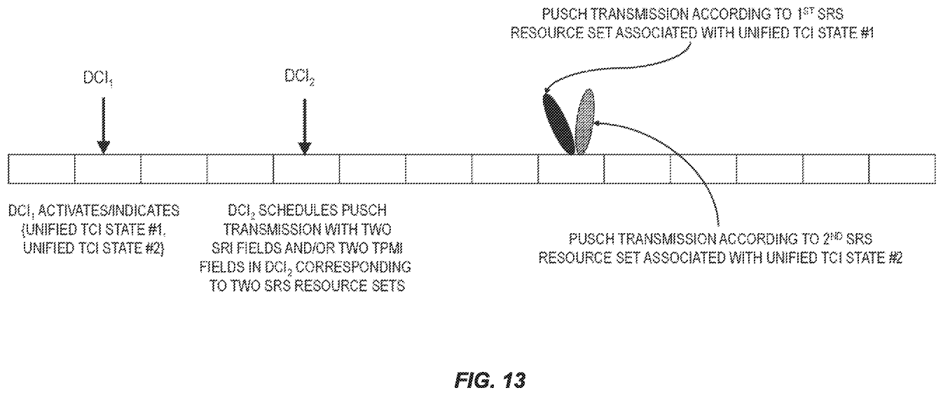

FIG. 15 shows a UE 1500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1502 may include multiple Central Processing Units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging the power source 1508. Power circuitry may perform any formatting, converting, or other modification to the power from the power source 1508 to make the power suitable for the respective components of the UE 1500 to which power is supplied.

The memory 1510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1510 may allow the UE 1500 to access instructions, application programs, and the like stored on transitory or non-transitory memory media, to off-load data, or to upload data. An article of manufacture, such as one utilizing a communication system, may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., the antenna 1522) and may share circuit components, software, or firmware, or alternatively be implemented separately.

In the illustrated embodiment, communication functions of the communication interface 1512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an ToT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

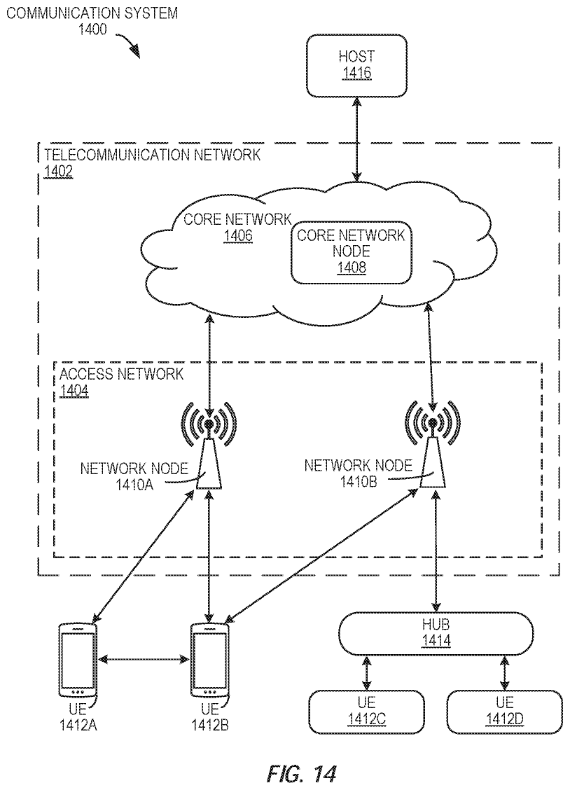

FIG. 16 shows a network node 1600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes processing circuitry 1602, memory 1604, a communication interface 1606, and a power source 1608. The network node 1600 may be composed of multiple physically separate components (e.g., a Node B component and an RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1600 may be configured to support multiple RATs. In such embodiments, some components may be duplicated (e.g., separate memory 1604 for different RATs) and some components may be reused (e.g., an antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1600.

The processing circuitry 1602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1600 components, such as the memory 1604, to provide network node 1600 functionality.

In some embodiments, the processing circuitry 1602 includes a System on a Chip (SOC). In some embodiments, the processing circuitry 1602 includes one or more of Radio Frequency (RF) transceiver circuitry 1612 and baseband processing circuitry 1614. In some embodiments, the RF transceiver circuitry 1612 and the baseband processing circuitry 1614 may be on separate chips (or sets of chips), boards, or units, such as radio units and digital units. In alternative embodiments, part or all of the RF transceiver circuitry 1612 and the baseband processing circuitry 1614 may be on the same chip or set of chips, boards, or units.

The memory 1604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and the memory 1604 are integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. The radio front-end circuitry 1618 comprises filters 1620 and amplifiers 1622. The radio front-end circuitry 1618 may be connected to the antenna 1610 and the processing circuitry 1602. The radio front-end circuitry 1618 may be configured to condition signals communicated between the antenna 1610 and the processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of the filters 1620 and/or the amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface 1606 may comprise different components and/or different combinations of components.

In certain alternative embodiments, the network node 1600 does not include separate radio front-end circuitry 1618; instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes the one or more ports or terminals 1616, the radio front-end circuitry 1618, and the RF transceiver circuitry 1612 as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, the communication interface 1606, and/or the processing circuitry 1602 may be configured to perform any receiving operations and/or certain obtaining operations described herein as being performed by the network node 1600. Any information, data, and/or signals may be received from a UE, another network node, and/or any other network equipment. Similarly, the antenna 1610, the communication interface 1606, and/or the processing circuitry 1602 may be configured to perform any transmitting operations described herein as being performed by the network node 1600. Any information, data, and/or signals may be transmitted to a UE, another network node, and/or any other network equipment.

The power source 1608 provides power to the various components of the network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid or an electricity outlet) via input circuitry or an interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

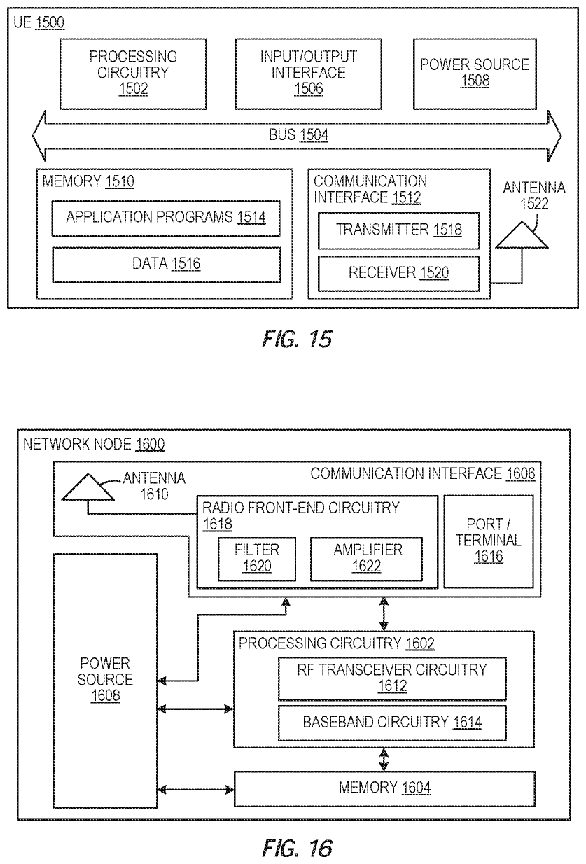

FIG. 17 is a block diagram of a host 1700, which may be an embodiment of the host 1416 of FIG. 14, in accordance with various aspects described herein. As used herein, the host 1700 may be or comprise various combinations of hardware and/or software including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of the host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for Over-The-Top (OTT) services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

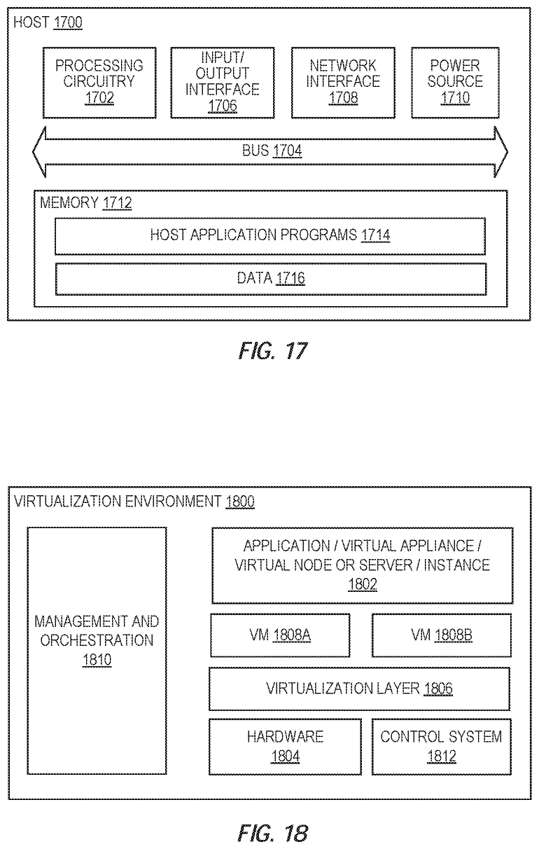

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or VM Monitors (VMMs)), provide VMs 1808A and 1808B (one or more of which may be generally referred to as VMs 1808), and/or perform any of the functions, features, and/or benefits described in relation with some embodiments described herein. The virtualization layer 1806 may present a virtual operating platform that appears like networking hardware to the VMs 1808.

The VMs 1808 comprise virtual processing, virtual memory, virtual networking, or interface and virtual storage, and may be run by a corresponding virtualization layer 1806. Different embodiments of the instance of a virtual appliance 1802 may be implemented on one or more of the VMs 1808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1808 may be a software implementation of a physical machine that runs programs as if they were executing on a physical, non-virtualized machine. Each of the VMs 1808, and that part of the hardware 1804 that executes that VM, be it hardware dedicated to that VM and/or hardware shared by that VM with others of the VMs 1808, forms separate virtual network elements. Still in the context of NFV, a virtual network function is responsible for handling specific network functions that run in one or more VMs 1808 on top of the hardware 1804 and corresponds to the application 1802.

The hardware 1804 may be implemented in a standalone network node with generic or specific components. The hardware 1804 may implement some functions via virtualization. Alternatively, the hardware 1804 may be part of a larger cluster of hardware (e.g., such as in a data center or CPE) where many hardware nodes work together and are managed via management and orchestration 1810, which, among others, oversees lifecycle management of the applications 1802. In some embodiments, the hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1812 which may alternatively be used for communication between hardware nodes and radio units.

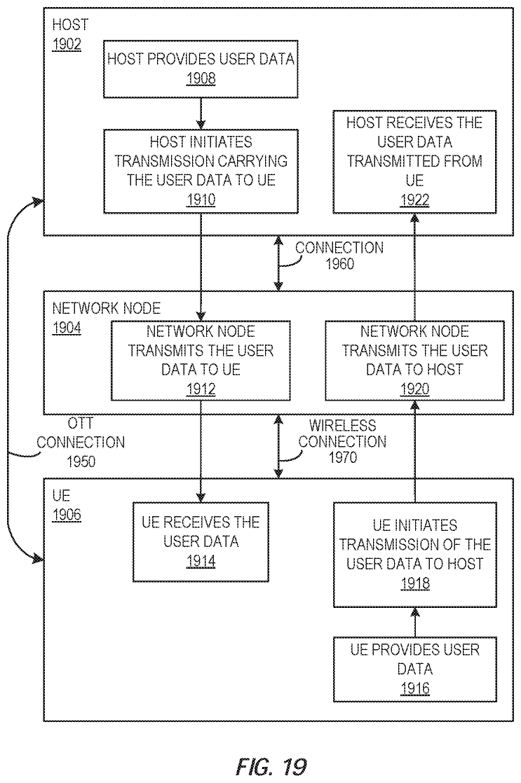

FIG. 19 shows a communication diagram of a host 1902 communicating via a network node 1904 with a UE 1906 over a partially wireless connection in accordance with some embodiments. Example implementations, in accordance with various embodiments, of the UE (such as the UE 1412A of FIG. 14 and/or the UE 1500 of FIG. 15), the network node (such as the network node 1410A of FIG. 14 and/or the network node 1600 of FIG. 16), and the host (such as the host 1416 of FIG. 14 and/or the host 1700 of FIG. 17) discussed in the preceding paragraphs will now be described with reference to FIG. 19.

Like the host 1700, embodiments of the host 1902 include hardware, such as a communication interface, processing circuitry, and memory. The host 1902 also includes software, which is stored in or is accessible by the host 1902 and executable by the processing circuitry. The software includes a host application that may be operable to provide a service to a remote user, such as the UE 1906 connecting via an OTT connection 1950 extending between the UE 1906 and the host 1902. In providing the service to the remote user, a host application may provide user data which is transmitted using the OTT connection 1950.

The network node 1904 includes hardware enabling it to communicate with the host 1902 and the UE 1906 via a connection 1960. The connection 1960 may be direct or pass through a core network (like the core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by the UE 1906 and executable by the UE's processing circuitry. The software includes a client application, such as a web browser or operator-specific “app” that may be operable to provide a service to a human or non-human user via the UE 1906 with the support of the host 1902. In the host 1902, an executing host application may communicate with the executing client application via the OTT connection 1950 terminating at the UE 1906 and the host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via the connection 1960 between the host 1902 and the network node 1904 and via a wireless connection 1970 between the network node 1904 and the UE 1906 to provide the connection between the host 1902 and the UE 1906. The connection 1960 and the wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904 in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR, or AR which it can broadcast, multicast, or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1950 between the host 1902 and the UE 1906 in response to variations in the measurement results. The measurement procedure and/or the network functionality for reconfiguring the OTT connection 1950 may be implemented in software and hardware of the host 1902 and/or the UE 1906. In some embodiments, sensors (not shown) may be deployed in or in association with other devices through which the OTT connection 1950 passes; the sensors may participate in the measurement procedure by supplying values of the monitored quantities exemplified above, or by supplying values of other physical quantities from which software may compute or estimate the monitored quantities. The reconfiguring of the OTT connection 1950 may include message format, retransmission settings, preferred routing, etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency, and the like by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a user equipment for transmission using two activated/indicated unified Transmission Configuration Indication, TCI, states, the method comprising one or more of: a. receiving a configuration comprising: a plurality of unified TCI states; and/or two Sounding Reference Signal, SRS, resource sets to be used for an uplink transmission; b. receiving a first Downlink Control Information, DCI, that activates/indicates a pair of unified TCI states; c. associating a first unified TCI state from the pair of unified TCI states to the first of the two SRS resource sets to be used for an uplink transmission, and associating a second unified TCI state from the pair of unified TCI states to the second of the two SRS resource sets to be used for uplink transmission; d. receiving a second DCI that schedules a first uplink transmission and a second uplink transmission associated with the first of the two SRS resource set and the second of the two SRS resource sets, respectively; e. transmitting the first uplink transmission according to a first spatial transmit filter derived from the first unified TCI state, and transmitting the second uplink transmission according to a second spatial transmit filter derived from the second unified TCI state.

Embodiment 2: The method of embodiment 1 wherein the first uplink transmission is a first Physical Uplink Shared Channel, PUSCH, transmission and the second uplink transmission is a second PUSCH transmission.

Embodiment 3: The method of any of the previous embodiments wherein receiving the configuration comprises receiving the configuration via Radio Resource Control, RRC.

Embodiment 4: The method of any of the previous embodiments wherein the PUSCH transmission(s)/repetition(s) associated with the first configured SRS resource set are transmitted using transmit spatial filter indicated by the first activated/indicated unified TCI state.

Embodiment 5: The method of any of the previous embodiments wherein the transmit power for the PUSCH transmission(s)/repetition(s) associated with the first configured SRS resource set is calculated according to a set of power control parameters associated with the first activated/indicated unified TCI state.

Embodiment 6: The method of any of the previous embodiments wherein the PUSCH transmission(s)/repetition(s) associated with the second configured SRS resource set are transmitted using transmit spatial filter indicated by the second activated/indicated unified TCI state.

Embodiment 7: The method of any of the previous embodiments wherein the transmit power for the PUSCH transmission(s)/repetition(s) associated with the second configured SRS resource set is calculated according to a set of power control parameters associated with the second activated/indicated unified TCI state.

Embodiment 8: The method of any of the previous embodiments, further comprising: providing user data; and forwarding the user data to a host via the transmission to the network node.

### Group B Embodiments

Embodiment 9: A method performed by a network node for receiving a transmission, the method comprising one or more of: a. transmitting, to a wireless device, a configuration comprising: a plurality of unified Transmission Configuration Indication, TCI, states; and/or two Sounding Reference Signal, SRS, resource sets to be used for an uplink transmission; b. transmitting, to the wireless device, a first Downlink Control Information, DCI, that activates/indicates a pair of unified TCI states; c. associating a first unified TCI state from the pair of unified TCI states to the first of the two SRS resource sets to be used for an uplink transmission, and associating a second unified TCI state from the pair of unified TCI states to the second of the two SRS resource sets to be used for uplink transmission; d. transmitting, to the wireless device, a second DCI that schedules a first uplink transmission and a second uplink transmission associated with the first of the two SRS resource set and the second of the two SRS resource sets, respectively; e. receiving, from the wireless device, the first uplink transmission according to a first spatial transmit filter derived from the first unified TCI state, and transmitting the second uplink transmission according to a second spatial transmit filter derived from the second unified TCI state.

Embodiment 10: The method of embodiment 9 wherein the first uplink transmission is a first Physical Uplink Shared Channel, PUSCH, transmission and the second uplink transmission is a second PUSCH transmission.

Embodiment 11: The method of any of the previous embodiments wherein transmitting the configuration comprises transmitting the configuration via Radio Resource Control, RRC.

Embodiment 12: The method of any of the previous embodiments wherein the PUSCH transmission(s)/repetition(s) associated with the first configured SRS resource set are transmitted using transmit spatial filter indicated by the first activated/indicated unified TCI state.

Embodiment 13: The method of any of the previous embodiments wherein the transmit power for the PUSCH transmission(s)/repetition(s) associated with the first configured SRS resource set is calculated according to a set of power control parameters associated with the first activated/indicated unified TCI state.

Embodiment 14: The method of any of the previous embodiments wherein the PUSCH transmission(s)/repetition(s) associated with the second configured SRS resource set are transmitted using transmit spatial filter indicated by the second activated/indicated unified TCI state.

Embodiment 15: The method of any of the previous embodiments wherein the transmit power for the PUSCH transmission(s)/repetition(s) associated with the second configured SRS resource set is calculated according to a set of power control parameters associated with the second activated/indicated unified TCI state.

Embodiment 16: The method of any of the previous embodiments, further comprising: obtaining user data; and forwarding the user data to a host or a user equipment.

### Group C Embodiments

Embodiment 17: A user equipment for transmission using two activated/indicated unified Transmission Configuration Indication, TCI, states, comprising: processing circuitry configured to perform any of the steps of any of the Group A embodiments; and power supply circuitry configured to supply power to the processing circuitry.

Embodiment 18: A network node for receiving a transmission, the network node comprising: processing circuitry configured to perform any of the steps of any of the Group B embodiments; power supply circuitry configured to supply power to the processing circuitry.

Embodiment 19: A user equipment (UE) for transmission using two activated/indicated unified Transmission Configuration Indication, TCI, states, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 20: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 21: The host of the previous embodiment, wherein the cellular network further includes a network node configured to communicate with the UE to transmit the user data to the UE from the host.

Embodiment 22: The host of the previous 2 embodiments, wherein: the processing circuitry of the host is configured to execute a host application, thereby providing the user data; and the host application is configured to interact with a client application executing on the UE, the client application being associated with the host application.

Embodiment 23: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 24: The method of the previous embodiment, further comprising: at the host, executing a host application associated with a client application executing on the UE to receive the user data from the UE.

Embodiment 25: The method of the previous embodiment, further comprising: at the host, transmitting input data to the client application executing on the UE, the input data being provided by executing the host application, wherein the user data is provided by the client application in response to the input data from the host application.

Embodiment 26: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 27: The host of the previous embodiment, wherein the cellular network further includes a network node configured to communicate with the UE to transmit the user data from the UE to the host.

Embodiment 28: The host of the previous 2 embodiments, wherein: the processing circuitry of the host is configured to execute a host application, thereby providing the user data; and the host application is configured to interact with a client application executing on the UE, the client application being associated with the host application.

Embodiment 29: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 30: The method of the previous embodiment, further comprising: at the host, executing a host application associated with a client application executing on the UE to receive the user data from the UE.

Embodiment 31: The method of the previous embodiment, further comprising: at the host, transmitting input data to the client application executing on the UE, the input data being provided by executing the host application, wherein the user data is provided by the client application in response to the input data from the host application.

Embodiment 32: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 33: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 34: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 35: The method of the previous embodiment, further comprising, at the network node, transmitting the user data provided by the host for the UE.

Embodiment 36: The method of any of the previous 2 embodiments, wherein the user data is provided at the host by executing a host application that interacts with a client application executing on the UE, the client application being associated with the host application.

Embodiment 37: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 38: The communication system of the previous embodiment, further comprising: the network node; and/or the user equipment.

Embodiment 39: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 40: The host of the previous 2 embodiments, wherein: the processing circuitry of the host is configured to execute a host application, thereby providing the user data; and the host application is configured to interact with a client application executing on the UE, the client application being associated with the host application.

Embodiment 41: The host of the any of the previous 2 embodiments, wherein the initiating receipt of the user data comprises requesting the user data.

Embodiment 42: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 43: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DCI Downlink Control Information
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
PUSCH Physical Uplink Shared Channel
QoS Quality of Service
RAM Random Access Memory
RAN Radio Access Network
ROM Read Only Memory
RRC Radio Resource Control
RRH Remote Radio Head
RTT Round Trip Time
SCEF Service Capability Exposure Function
SMF Session Management Function
SRI SRS Resource Indicator
SRS Sounding Reference Signal
TCI Transmission Configuration Indication
TPMI Transmit Precoding Matrix Indicator
TRP Transmission Reception Point
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for transmission using two activated/indicated unified Transmission Configuration Indication, TCI, states, the method comprising at least one of:
receiving a configuration of a plurality of unified TCI states and a first and a second Sounding Reference Signal, SRS, resource sets, where the first and the second SRS resource sets are for either codebook based or non-codebook based usage;
receiving a first Downlink Control Information, DCI, that activates/indicates a first and a second unified TCI states out of the plurality of unified TCI states for uplink channels;
receiving a second DCI that schedules one of:
(a) a first uplink transmission in a first set of transmission occasions associated to the first SRS resource set;
(b) a second uplink transmission in a second set of transmission occasions associated to the second SRS resource set, and
(c) a first and a second uplink transmissions in a first set and a second set of transmission occasions, respectively;
and performing at least one of:
(i) applying the first unified TCI state to the uplink channel transmission in the first set of transmission occasions;
(ii) applying the second unified TCI state to the uplink channel transmission in the second set of transmission occasions; and
(iii) applying the first and the second unified TCI states to the uplink channel transmission in the first set and the second set of transmission occasions, respectively.

2-34. (canceled)
